(19) United States
(12) Patent Application Publication
(10) Pub. No.: US 2009/0268680 A1
(43) Pub. Date: Oct. 29, 2009

(54) SIGNALING FORMATS FOR INDICATING UNUSED RESOURCE BLOCKS IN LTE SYSTEMS

(75) Inventors: Young-Han Nam, Plano, TX (US); Jianzhong Zhang, Irving, TX (US); Zhouyue Pi, Richardson, TX (US); Farooq Khan, Allen, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/411,251

(22) Filed: Mar. 25, 2009

Related U.S. Application Data
(60) Provisional application No. 61/071,425, filed on Apr. 28, 2008.

(51) Int. Cl. H04W 72/04; H04L 12/28

(52) U.S. Cl. 370/329; 370/400

(57) ABSTRACT

Systems and methods are disclosed for use in a wireless communication system including a base station configured to identify unused PRBS. This base station includes a communication unit that is in communication with at least one subscriber station and a processor configured to identify at least one PRB as unused. Upon determining that at least one PRB is unused, the base station transmits information related to the unused PRBs to the at least one subscriber station through a control message.

### CROSS-REFERENCE TO RELATED APPLICATION(S) AND CLAIM OF PRIORITY

The present application is related to U. S. Provisional Patent No. 61/071,425, filed Apr. 28, 2008, entitled “SIGNALING FORMATS FOR INDICATING UNUSED RESOURCE BLOCKS IN LTE SYSTEMS”. Provisional Patent No. 61/071,425 is assigned to the assignee of the present application and is hereby incorporated by reference into the present application as if fully set forth herein. The present application hereby claims priority under 35 U.S.C. §119(e) to U.S. Provisional Patent No. 61/071,425.

### TECHNICAL FIELD OF THE INVENTION

The present application relates generally to communications systems and, more specifically, to indicating unused resource blocks in systems that use the long term evolution (LTE) project.

### BACKGROUND OF THE INVENTION

In an Orthogonal Frequency-Division Multiple Access (OFDMA) system, interference power often varies in frequency and time due to frequency and time selective fading. In addition, interference power often varies in frequency and time due to frequency and time domain power adaptation. It is important for the system design to take advantage of interference power variation to maximize system performance. Therefore, systems and methods that could be used to accurately measure interference would be helpful.

### SUMMARY OF THE INVENTION

A method is disclosed for use in a wireless communication system including a base station configured to identify unused physical resource blocks (PRBs). This base station includes a communication unit that is in communication with at least one subscriber station and a processor configured to identify at least one PRB as unused. Upon determining that a PRB is unused, the base station transmits information related to the unused resource blocks to the at least one subscriber station through a control message.

In another embodiment, a method is disclosed that includes receiving a control message with information related to unused PRBs. This control message is received through at least one hardware communications interface. In addition, this method includes obtaining information from signals received within the unused PRBS. The information is obtained by processing the signals through at least one processor.

In yet another embodiment, a method of indentifying unused PRBs in a wireless communication system is disclosed that includes determining at least one PRB is in an unused state in a wireless network using at least one data processor. This method also includes encoding information relating to the at least one unused PRB into a control message and transmitting the control message using at least one communication interface.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits ACK/NACK messages in the uplink according to the principles of the present disclosure.

FIG. 2A is a high-level diagram of an orthogonal frequency division multiple access (OFDMA) transmit path.

FIG. 2B is a high-level diagram of an orthogonal frequency division multiple access (OFDMA) receive path.

FIG. 3 illustrates a method of mapping data using the disclosed systems and methods.

FIG. 4 illustrates another method of mapping data using the disclosed systems and methods.

FIG. 5 illustrates a further method of mapping data using the disclosed systems and methods.

FIG. 6 illustrates a flowchart used to determine and transmit unused PRBs available for interference measurement.

FIG. 7 illustrates a computer system capable of implementing the various embodiments of the present disclosure.

### DETAILED DESCRIPTION OF THE INVENTION

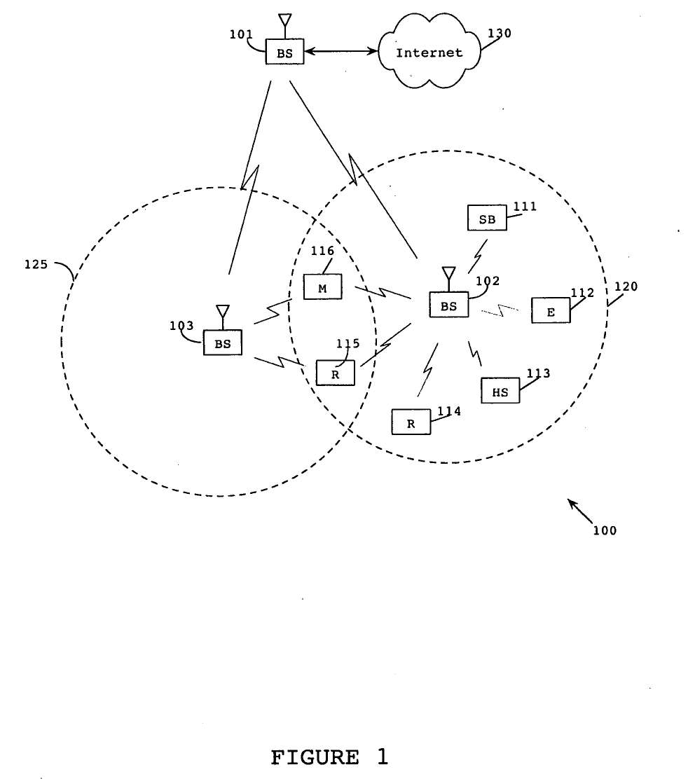

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged to indicate unused resource blocks in LTE systems.

Unused time-frequency resources (e.g., sub-carriers) are often available due to Hybrid Automatic Repeat ReQuest (HARQ) early termination, flexible frequency reuse, etc. Also, a base station may intentionally reserve some sub-carriers unused, for a certain period of time. The period of time can be as short as one subframe, or as long as seconds, minutes, or hours. An “unused” sub-carrier refers to those sub carriers on which a base station does not transmit any signal waveform on, i.e., no transmission power is allocated to those sub-carriers. Mobile stations then can utilize these unused sub-carriers for interference estimation. Because of the dynamic nature of which sub-carriers may become unused due to scheduling, HARQ early termination, and flexible frequency reuse etc., a base station may use signaling messages and/or control channel messages to indicate the positions of these sub-carriers to mobile stations.

In the next generation wide-area wireless systems, such as 3GPP LTE and IEEE 802.16 systems, a few downlink (DL) control message formats are defined so that a base station efficiently informs a mobile station of assigned resources and some other information on different purposes. It is understood that by using these control messages, unused resource blocks may be identified.

In 3GPP LTE systems, DCI format 1A is defined for a compact transmission of downlink shared channel (DL-SCH) assignments for SIMO operation, and DCI format 1C is defined for downlink transmission of paging, random-access-channel (RACH) response and dynamic broadcast channel (BCCH) scheduling. In both of these DCI formats, there is a radio network temporary identifier/Cyclic Redundancy Code (RNTI/CRC) field, used for indicating a user equipment (UE) that the current control message is intended for. In the current working assumption of 3GPP LTE, the number of bits assigned for RNTI/CRC is the same for all these DCI formats, as shown by Equation 1.

N_{RNTI}^{1A}=N_{RNTI}^{1C} [Eqn. 1]

There is another common field in both of DCI formats, which is the resource-block (RB) assignment field. In the current working assumption of 3GPP LTE, for a given number of system RBs, or N_{RB}^{DL}, DCI format 1A has the larger number of bits for the RB assignment than format C, as shown in Equation 2.

N_{RBA}^{1A}(N_{RB}^{DL})≧N_{RBA}^{1C}(N_{RB}^{DL}) [Eqn. 2]

Using the control message sent by the base station containing the information within the various DCI formats, unused RBs can be identified at UEs served by the base station.

In one embodiment, unused resource blocks may be used to estimate interference at UEs. The measurement of interference within the LTE system may be used to optimize performance of the network. Normally interference may be based on either pilot channel or data channel. The estimation is often coupled with channel estimation or data channel detection, which requires complicated receiver design, and often leads to unsatisfactory results. In an OFDMA system such as 3GPP LTE systems, this problem is exacerbated because the reference signals are only located in a few OFDM symbols. If all base stations are synchronized, in some OFDM symbols reference signals collide with each other while there are no reference signals in other OFDM symbols. Therefore, the interference estimation based on reference signals can be much higher than the actual interference power level experienced by data channel in a lightly loaded system, which may result in pessimistic CQI reporting and poor system performance. Once the unused RBs are identified, interference estimation may be performed by the UE.

In another embodiment, a wireless operator may provide a service to mobile subscribers allowing them to know their positions, similar to a GPS service. One method of providing location services, called OTDOA (Observed Time Difference Of Arrival), allows subscribers to measure and utilize the time difference of the arrivals of the signals from different base stations. This time difference allows for the positioning calculation of the UE. For the OTDOA method, hearability is an issue that needs to be taken into account, i.e., a terminal near its serving cell cannot hear other cells on the same resource. For this hearability issue, th e message of indicating unused PRBs may be sent out (broadcasted) by the serving base station to UEs in order to inform the UEs the set of PRBs they are supposed to listen to the neighbor cell's signals for its positioning measurement purpose.

FIG. 1 illustrates exemplary wireless network 100. In the illustrated embodiment, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

It us understood that the base station 101 might be a base station, referred to as a “NodeB” or an enhanced base station, referred to as an “eNodeB”. Any type of base station capable of communication with various subscriber stations may be use consistent with the present disclosure.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

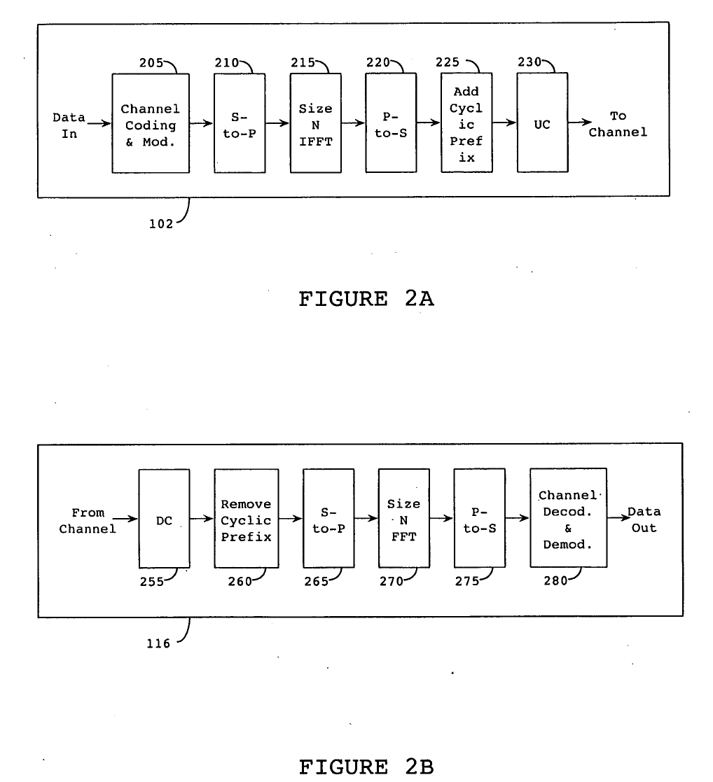

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes systems and methods for sending a control message to at least one user equipment (UE) informing the UE of unused resource blocks (RBs) in a wireless communication system.

In one embodiment of the invention, the eNodeB transmits a message with an identifier and indication of unused RBs for the purpose of interference estimation. In addition, a special medium access control identification (MAC-ID) (or RNTI or common ID) can be used to mask the CRC bits of this message. When eNodeB wants to indicate the resources that are not used for transmission or that may be used by UEs for interference estimation, the eNodeB transmits the message with the resource indication using a special MAC ID. UEs can monitor the messages with this special MAC ID. If this message is detected, correctly decoded, and the MAC ID matches with the special MAC ID, a UE can use the resources indicated in the message to improve interference estimation.

In another embodiment of the invention, eNodeB sends out a control message or a few control messages in a certain downlink-control-information (DCI) format for informing every UE in a cell of a subset or the set of unused RBs. Throughout this disclosure this control message will be referred to as control message X.

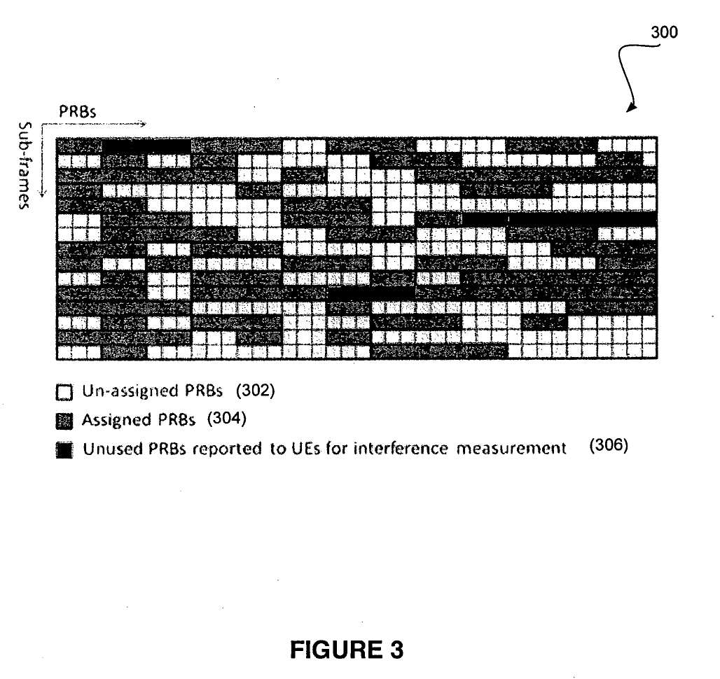

FIG. 3 is an example 300 illustrating one scheme of informing a UE of unused RBs. In this example, the resource allocation field of DCI format 1A in 3GPP LTE specification TS 36.212 can be utilized for informing the UEs of the location of a set of unused consecutive physical RBs (PRBs) 306. Here we call the resource allocation field in the DCI format 1A the unused RB indicator (URI) field. In FIG. 3, the system has 40 DL PRBs, i.e., N_{RB}^{DL}=40 and the base station sends out control message X every 5 sub-frames. At subframes 0, 5 and 10, the URI field of format 1A describes the largest set of unused consecutive PRBs. If there are unused subframes available for interference measurement, the control message X will indicate the presence of such a PRB. If the PRB is unassigned but not available for UE interference measurement, the control message X will also indicate this state. The fact that a PRB is unassigned does not mean that it will always be available for interference measurement. Therefore, the control message X is capable of conveying, in some embodiments, an unassigned PRB state 302, an assigned PRB state 304, as well as an unused PRBs reported to the UEs for interference measurement 306.

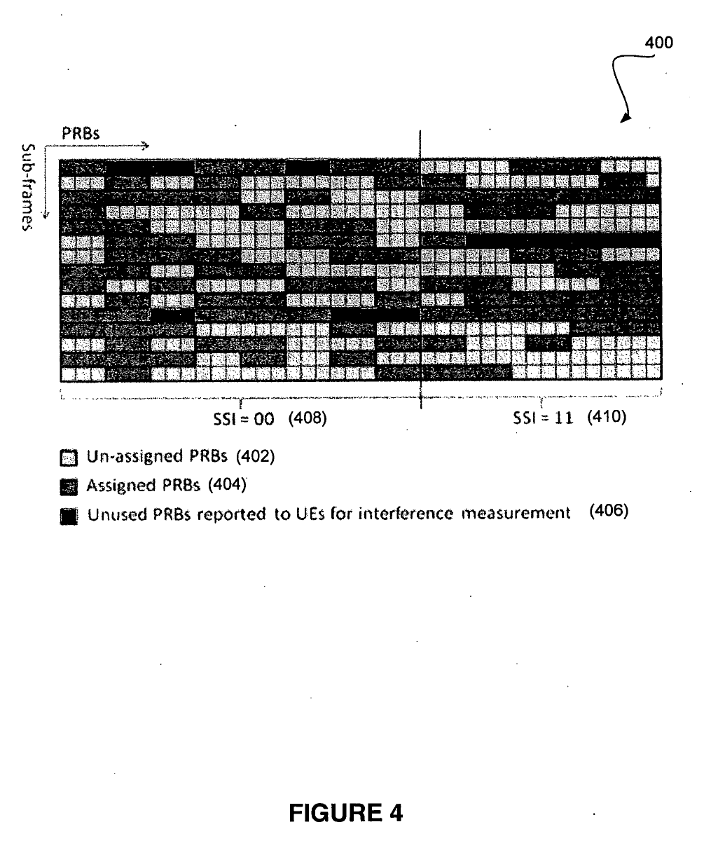

FIG. 3 illustrated one way of indicating consecutive unused PRBs available for interference, while FIG. 4 illustrates an example 400 of indicating the presence of all unused PRBs available for interference estimation for the entire system through a single control message X. FIG. 4 illustrates the used of DCI format 1D which may have the same size as DCI format 1A in 3GPP LTE specification TS 36.212. In DCI format 1D, a field of length N_{UR1}^{1D}(N_{RB}^{DL}) is defined for describing the set of unused RBs in the system bandwidth, in addition to the RNTI/CRC field. The length of this unused RB indication field is 0<N_{URI}^{1D}(N_{RB}^{DL})≦(Total length of this format)−N_{RNTI}^{1D}. The field assignment for format 1D is shown in Table 2. An illustrative example of this method is shown in FIG. 4. In this figure, the system has 40 DL PRBs, i.e., N_{RB}^{DL}=40 and the eNodeB transmits control message X every 5 sub-frames. At subframes 0, 5 and 10, the URI field of format 1D completely describes the set of unused PRBs. In the example shown in FIG. 4, unassigned PRBs 402, assigned PRBs 404, and unused PRBs reported to UEs for interference measurement 406 are shown. Also, in the example shown in FIG. 4, all of the unused PRBs available for interference measurement are transmitted in the single control message X.

TABLE 2
Method B: DCI format 1D used for control message

| RNTI/CRC | Unused RB Indicator length | Unused bit length |
|---|---|---|
| N_{RNTI}^{1D} | N_{URI}^{1D}(N_{RB}^{DL}) | (total length of this format) − |
| | | N_{RNTI}^{1D} − N_{URI}^{1D}(N_{RB}^{DL}) |

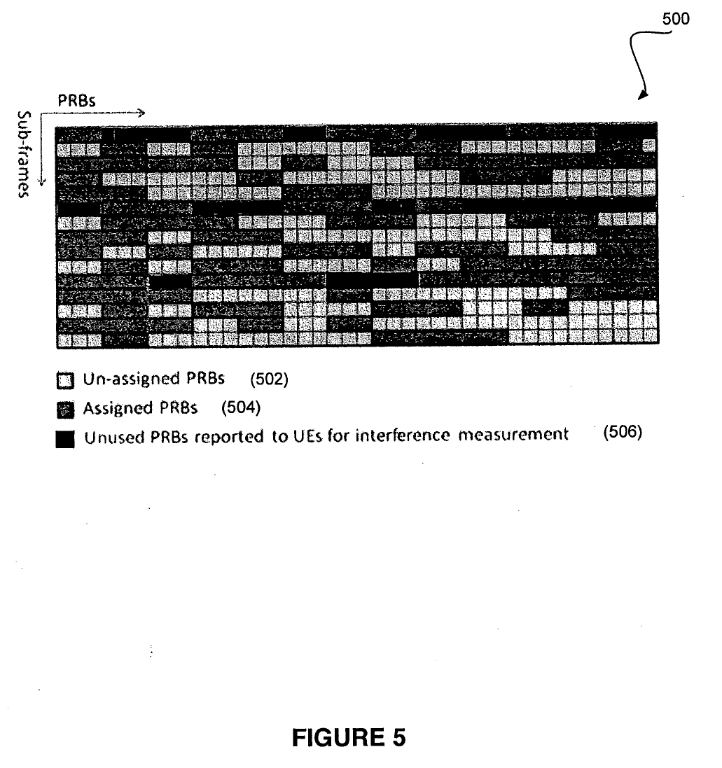

FIG. 5 illustrates another embodiment of informing UEs of the unused RBs using DCI formats 1E or 1F. DCI format 1E has only two fields, RNTI/CRC and URI field, whereas DCI format 1F has three fields, RNTI/CRC, URI and subset index (SSI). The field assignment for formats 1E and 1F is shown in Table 3 and Table 4, respectively, shown below.

TABLE 3
Method C: DCI format 1E used for control message

| RNTI/CRC | Unused RB Indicator length |
|---|---|
| N_{RNTI}^{1C} | N_{URI}^{1E} = N_{RBA}^{1C}(N_{RB}^{DL}) + N_{Other}^{1C} |

TABLE 4
Method C: DCI format 1F used for control message

| RNTI/ | | Subset Index |
|---|---|---|
| CRC | Unused RB Indicator length | length |
| N_{RNTI}^{1C} | N_{URI}^{1F} = N_{RBA}^{1C}(N_{RB}^{DL}) + N_{Other}^{1C} − N_{SSI}^{1F} | N_{SSI}^{1F} |

In both formats 1E and 1F, the URI field indicates either a subset or the set of unused RBs in the system bandwidth. This approach has a coverage advantage over the method illustrated in FIG. 4. However, it may not always be able to describe the empty RBs using a single control message. When the number of bits assigned to the URI field is not large enough to completely describe the set of unused RBs in the whole system bandwidth, various approaches can be utilized as shown in the following examples.

In a signaling method used to overcome the problem of when the URI field is not large enough to completely describe the set of unused RBs, the system RBs are partitioned into subsets so that the URI field in a single control message X can describe the complete or a part of unused RBs within a subset. For this method, both DCI formats 1E and 1F can be utilized. Let the total number of these subsets in a cell be N_{Subsets}^{C1}(N_{RB}^{DL}), which may vary upon N_{RB}^{DL}. For a given N_{RB}^{DL}, N_{Sublets}^{C1}(N_{RB}^{DL})−1 subsets are of an equal size, P_{Subset}^{C1}(N_{RB}^{DL}) RBs, while the last subset may have a smaller number of RBs than P_{Subset}^{C1}(N_{RB}^{DL}); thus N_{Subsets}^{C1}(N_{RB}^{DL})=┌N_{RB}^{DL}/P_{Subset}^{C1}(N_{RB}^{DL})┐.

A specific example of using the signaling method is shown in FIG. 5 and described by using P_{Subset}^{C1}(N_{RB}^{DL}), where P_{Subset}^{C1}(N_{RB}^{DL}) is chosen to be the RB-group (RBG) size. At a given sub-frame, the URI field describes the unused RBs within a single subset of size P_{Subset}^{C1}(N_{RB}^{DL}) utilizing resource allocation types in any way defined in the incorporated materials. For informing the UEs of the subset index which the current message X is about, various approaches can be considered. For example, when format 1E is utilized, a mapping between the subset index and the sub-frame index (or other indices available to both UE and the eNodeB) can be defined. For another example, when format 1F is utilized, the subset index can be explicitly informed to the UEs via the service set identifier (SSI) field. In cases where P_{Subsets}^{C1}(N_{RB}^{DL})=1, the signaling of the subset index is not required.

In an example 500 shown in FIG. 5, the system has 40 DL PRBs, i.e., N_{RB}^{DL}=40, and the eNodeB transmits control message X every 5 sub-frames. In this example, the RBG size is 3 for N_{RB}^{DL}=40 P_{Subset}^{C1}(N_{RB}^{DL})=3 and N_{Subsets}^{C1}(N_{RB}^{DL})=2 is chosen. The system RBs are divided into two partitions by the black line separating sections SSI=00 508 and SSI=11 510 in FIG. 5. It can be assumed that 10 bits are available in format 1C excluding RNTI/CRC bits, and therefore there are 8 bits assigned for the URI field, and 2 bits assigned for the SSI field for format 1F. Since in each partition there are less than 8 subsets of size less than 3 RBs, 8 bits are enough to indicate the unused subsets. For example, at subframe 0, for control message X, format 1F is used with the URI field 01100100 and the SSI field 00. Here, each bit in the URI field indicates whether a subset is empty or not. If it is empty, the bit is 1, otherwise it is 0. SSI field 00 508 indicates the left partition, whereas SSI field 11 510 indicates the right partition. The assignment of the unassigned PRBs 502, assigned PRBs 504, and unused PRBs reported to UEs for interference measurement 506 are all shown in FIG. 5.

In a second signaling method, there is only one control message X for describing a subset of the unused RBs within the whole bandwidth. For this method, DCI format 1E will be utilized. In this method, the system RBs are partitioned into subsets, so that the number of such subsets N_{Subsets}^{C2}(N_{RB}^{DL}) is smaller than the number of bits assigned for the URI field. For a given N_{RB}^{DL}, N_{Subsets}^{C2}(N_{RB}^{DL})−1 groups are of an equal size, P_{Subset}^{C2}(N_{RB}^{DL}) RBs, while the last group may have a smaller number of RBs than P_{Subset}^{C2}(N_{RB}^{DL}). Thus N_{Subsets}^{C2}(N_{RB}^{DL})=┌N_{RB}^{DL}/P_{Subset}^{C2}(N_{RB}^{DL})┐.

A specific example of this second signaling method is described as in the following where N_{Subsets}^{C2}(N_{RB}^{DL}) is chosen to be N_{URI}^{1E}(N_{RB}^{DL}). At a given sub-frame, the URI field describes a group of unused RBs, where each bit in the field describes whether a subset is assigned to a UE or not. The exemplary system has 40 DL PRBs, i.e., N_{RB}^{DL}=40 and the eNodeB transmits control message X every 5 sub-frames. In this example, the values N_{Subsets}^{C2}(N_{RB}^{DL})=10 and P_{Subset}^{C2}(N_{RB}^{DL})=4 may be chosen, where it may be assumed that 10 bits are available in format 1C excluding RNTI/CRC bits. The 10 bits are used in the URI field in format 1E to describe unused subsets in the system. For example, at subframe 0, the URI field has 0100001001, where each bit in the URI field indicates whether a subset is empty or not; if it is empty, the bit is 1; otherwise the bit is 0.

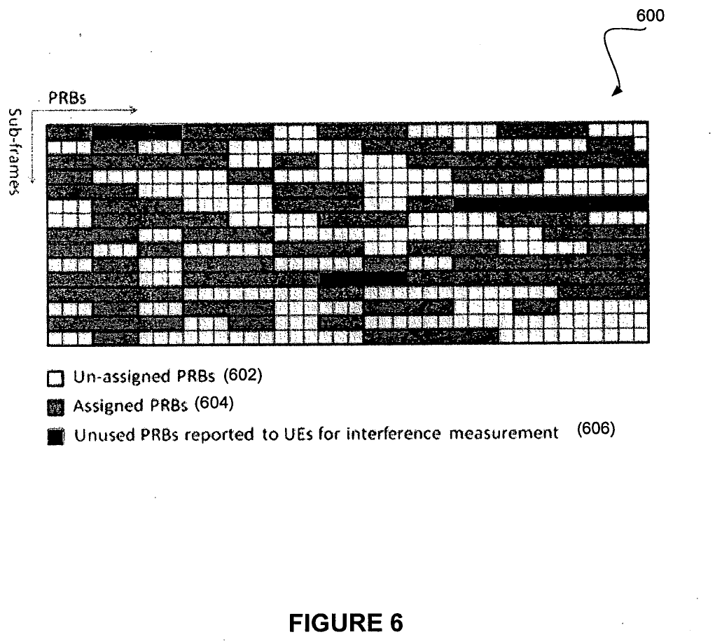

FIG. 6 is a flowchart of one method of using the presently disclosed systems and methods. In this flowchart 600, the DCI format for conveying information related to the unused PRBs available for interference measurement by an eNodeB is selected in Block 602. These formats may be any format discussed above, or any other format known to one skilled in the art or appearing in the cited references that have been incorporated herein. The eNodeB determines which PRBs are available for interference measurement in block 604. Since the eNodeB communicates with each UE, UEs may be able to determine which PRBs should be used for interference measurement in block 606. In block 608 the UE measures interference using the PRBs indicated by the eNodeB.

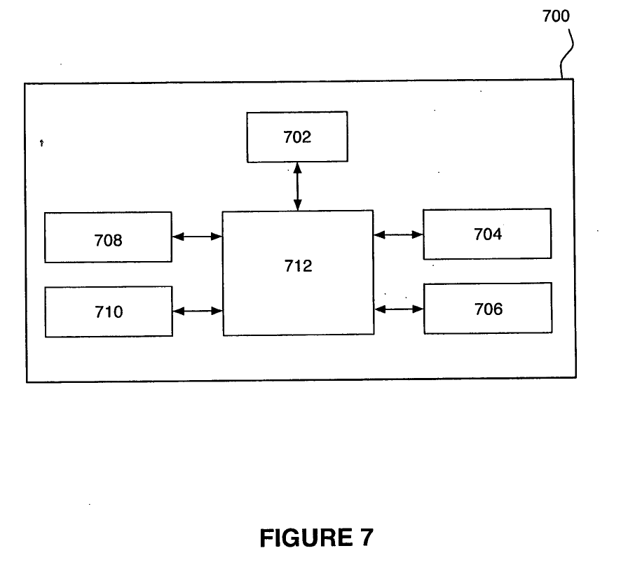

FIG. 7 is a computing device capable of implementing the various systems and methods, including the encoding of data into the DCI formats specified above. FIG. 7 illustrates a computer system suitable for implementing one or more embodiments disclosed herein, including the encoding, storing, transmitting, and decoding of data. The computer 700 includes a processor 712 (which may be referred to as a central processor unit or CPU) that is in communication with memory devices including secondary storage 710, read only memory (ROM) 704, random access memory (RAM) 706, input/output (I/O) 708 devices, and network connectivity devices 702. The processor may be implemented as one or more CPU chips.

The secondary storage 700 is typically comprised of one or more disk drives or tape drives and is used for non-volatile storage of data and as an over-flow data storage device if RAM 706 is not large enough to hold all working data. Secondary storage 700 may be used to store programs that are loaded into RAM 706 when such programs are selected for execution. The ROM 704 is used to store instructions and perhaps data that are read during program execution. ROM 704 is a non-volatile memory device that typically has a small memory capacity relative to the larger memory capacity of secondary storage. The RAM 706 is used to store volatile data and perhaps to store instructions. Access to both ROM 704 and RAM 706 is typically faster than to secondary storage 710.

I/O 708 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 702 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 702 may enable the processor 712 to communicate with an Internet or one or more intranets. With such a network connection, it is contemplated that the processor 712 might receive information from the network, or might output information to the network in the course of performing the above-described method steps. Such information, which is often represented as a sequence of instructions to be executed using processor 712, may be received from and outputted to the network, for example, in the form of a computer data signal embodied in a carrier wave.

Such information, which may include data or instructions to be executed using processor 712 for example, may be received from and outputted to the network, for example, in the form of a computer data baseband signal or signal embodied in a carrier wave. The baseband signal or signal embodied in the carrier wave generated by the network connectivity devices 702 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 712 executes instructions, codes, computer programs, scripts that it accesses from hard disk, floppy disk, optical disk (these various disk based systems may all be considered secondary storage 710), ROM 704, RAM 706, or the network connectivity devices 710.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication system, a base station configured to identify unused physical resource blocks (PRBs), said base station comprising:
a communication unit, wherein the communication unit is in communication with at least one subscriber station;
a processor, wherein the processor is configured to identify at least one PRBs that is unused, and upon determining that a PRBs is unused, transmitting the information related to the unused PRBs to the at least one subscriber station through a control message.

2. The base station of claim 1, wherein base station also transmits information related to unused PRBs that are available to the at least one subscriber station to be used to determine the location of the at least one subscriber station.

3. The base station of claim 1, wherein a special medium access control identification (MAC-ID) is used to mask CRC bits of the control message.

4. The base station of claim 1, wherein the base station is an eNodeB base station.

5. The base station of claim 1, wherein base station transmits information related to unused PRBs that are available to the at least one subscriber station for interference measurement.

6. The base station of claim 1, wherein the control message comprises information indicating all the unused PRBs in the system bandwidth.

7. The base station of claim 1, wherein the control message comprises information indicating at least one set of consecutive unused PRBs available in the system bandwidth.

8. A method, comprising:
receiving a control message with information related to unused PRBS, wherein the control message is received through at least one hardware communications interface; and
obtaining information from signals received within the unused PRBS, wherein the information is obtained by processing the signals through at least one processor.

9. The method of claim 8, further comprising obtaining the information from unused PRBs that are available for interference measurement.

10. The method of claim 9, further comprising adjusting the operation of at least one subscriber station based upon the measured interference.

11. The method of claim 8, wherein CRC bits of the control message have been masked using a special medium access control identification (MAC-ID).

12. The method of claim 8, further comprising obtaining the information from unused PRBs that are available for position determination.

13. The method of claim 8, wherein a subset of the unused PRBs are designated as available for interference detection by the control message.

14. The method of claim 8, further comprising sharing the information related to the measured interference with at least one base station.

15. A method of indentifying unused PRBs in a wireless communication system, comprising:
determining at least one PRBs is in an unused state in a wireless network using at least one data processor;
encoding information relating to the at least one used PRBs into a control message; and
transmitting the control message using at least one communication interface.

16. The method of claim 15, wherein the control message is received by a subscriber station.

17. The method of claim 16, wherein the subscriber station measures interference by processing the signals within the unused PRBs.

18. The method of claim 16, wherein the subscriber station determines the position of the subscriber station by processing signals within the unused PRBS.

19. The method of claim 15, wherein the control message contains information related to both unused PRBs available for interference measurement and unused PRBs available for position determination.

20. The method of claim 15, wherein the method is performed by an eNodeB.
